(19) United States
(12) Patent Application Publication
(10) Pub. No.: US 2007/0222738 A1
(43) Pub. Date: Sep. 27, 2007

(54) Luminance control device, display device, luminance control method, luminance control program, and recording medium storing the luminance control program

(75) Inventor: Takuma Yoshida, Tokyo (JP)

Correspondence Address: KRATZ, QUINTOS & HANSON, LLP, 1420 K Street, N.W., Suite 400, WASHINGTON, DC, 20005, US

(73) Assignee: PIONEER CORPORATION, Tokyo (JP)

(21) Appl. No.: 11/727,034

(22) Filed: Mar. 23, 2007

(30) Foreign Application Priority Data
Mar. 27, 2006 (JP) 2006-084982

(51) Int. Cl. G09G 3/36

(52) U.S. Cl. 345/101

(57) ABSTRACT

Provided is a display device (100) which predicts a predicted temperature difference between a peripheral display area and an outer peripheral area of a display section (200) based on an input image signal from an image-signal input section (10). When the predicted temperature difference is a set reference value or more, the display device (100) controls luminance of an image displayed on the peripheral display area so as to be lowered. Therefore, the predicted temperature difference is predicted by using only the input image signal, and the luminance of the image displayed on the peripheral display area can be appropriately controlled without performing a calculation using the predicted temperature difference. Hence, such a luminance control for preventing breakage of the display section (200) can be easily performed.

### BACKGROUND OF THE INVENTION

1. Field of the Invention

The present invention relates to a luminance control device, a display device, a luminance control method, and a luminance control program, for controlling luminance of an image displayed on a display section, and to a recording medium storing the luminance control program.

2. Description of Related Art

Heretofore, there has been known an arrangement in which luminance of an image is adjusted in order to prevent breakage of a display section (see, for example, JP 3270435 B, from the left column of page 4 to the left column of page 11).

In the arrangement described in JP 3270435 B, an estimated temperature value representing a temperature of an outer peripheral portion of a display screen of a plasma display panel (PDP) is obtained from a picture signal. Further, an estimated temperature difference value is obtained by subtracting, from the estimated temperature value, a reference value representing a temperature of the outer peripheral portion of the panel, which is outputted from an instrument for setting the temperature of the outer peripheral portion of the panel. Then, based on the estimated temperature difference value, the luminance of the image displayed on the display section is controlled by a controller and a luminance controller. Such an arrangement as described above is adopted.

However, in the arrangement as described in JP 3270435 B, the estimated temperature difference value is obtained by a calculation using the estimated temperature value and the reference value. Accordingly, for example, control processing for the luminance may become complicated.

### SUMMARY OF THE INVENTION

An object of the present invention is to provide a luminance control device, a display device, a luminance control method, a luminance control program capable of controlling the luminance of the display section so that breakage of the display section can be prevented, and a recording medium storing the luminance control program

According to an aspect of the present invention, a luminance control device that controls luminance of an image displayed on a display section with luminance according to an input image signal inputted from an outside, the display section including: a display area that can display the image thereon, the display area having a center display area and a peripheral display area surrounding the center display area; and an outer peripheral area that cannot display the image thereon, the outer peripheral area surrounding the display area the luminance control device includes: a temperature-difference prediction section that predicts a predicted temperature difference between the peripheral display area and the outer peripheral area based on the input image signal; and a luminance control section that performs a control such that the luminance of the image displayed on the peripheral display area is lowered in accordance with an increase of the predicted temperature difference.

According to another aspect of the present invention, a luminance control device that controls luminance of an image displayed on a display section with luminance according to an input image signal inputted from an outside, the display section including: a display area that can display the image thereon, the display area having a center display area and a peripheral display area surrounding the center display area; and an outer peripheral area that cannot display the image thereon, the outer peripheral area surrounding the display area, the luminance control device includes: a display-image-signal generating section that generates, based on the input image signal, a display image signal outputted to the display section and allowing the image to be displayed thereon; a temperature-difference prediction section that predicts a predicted temperature difference between the peripheral display area and the outer peripheral area based on the display image signal; and a luminance control section that performs a control such that the luminance of the image displayed on the peripheral display area is lowered in accordance with an increase of the predicted temperature difference.

A display device according to still another aspect of the present invention, includes: a display section including: a display area that can display an image thereon, the display area having a center display area and a peripheral display area surrounding the center display area; and an outer peripheral area that cannot display the image thereon, the outer peripheral area surrounding the display area, the display section displaying the image with luminance according to an input image signal inputted from an outside; and the above-mentioned luminance control device of the present invention that controls the luminance of the image displayed on the display section.

According to yet another aspect of the present invention, a luminance control method of controlling luminance of an image displayed on a display section with luminance according to an input image signal inputted from an outside, the display section including: a display area that can display the image thereon, the display area having a center display area and a peripheral display area surrounding the center display area; and an outer peripheral area that cannot display the image thereon, the outer peripheral area surrounding the display area, the luminance control method performed by a computing unit, includes: predicting a predicted temperature difference between the peripheral display area and the outer peripheral area based on the input image signal; and controlling the luminance of the image displayed on the peripheral display area so as to be lowered in accordance with an increase of the predicted temperature difference.

According to further aspect of the present invention, a luminance control method of controlling luminance of an image displayed on a display section with luminance according to an input image signal inputted from an outside, the display section including: a display area that can display the image thereon, the display area having a center display area and a peripheral display area surrounding the center display area; and an outer peripheral area that cannot display the image thereon, the outer peripheral area surrounding the display area, the luminance control method performed by a computing unit, includes: generating a display image signal outputted to the display section and allowing the image to be displayed thereon, based on the input image signal; predicting a predicted temperature difference between the peripheral display area and the outer peripheral area based on the display image signal; and controlling the luminance of the image displayed on the peripheral display area so as to be lowered in accordance with an increase of the predicted temperature difference.

A luminance control program according to a further aspect of the present invention operates a computing unit to function as the above-mentioned luminance control device of the present invention.

A luminance control program according to further aspect of the present invention operates a computing unit to execute the above-mentioned luminance control method of the present invention.

A recording medium according to further aspect of the present invention stores the above-mentioned luminance control program of the present invention in a manner readable by a computing unit.

### BRIEF DESCRIPTION OF THE DRAWINGS

FIG. 1 is a block diagram showing a schematic arrangement of a display device according to an embodiment of the present invention;

FIG. 2A is a front view showing a schematic arrangement of a display section according to the embodiment;

FIG. 2B is a side view showing the schematic arrangement of the display section according to the embodiment;

FIG. 3 is a schematic view showing blocks for which peak-detecting APLs and still-image-detecting APLs are to be calculated according to the embodiment;

FIG. 4 is a schematic view showing blocks for which the peak-detecting APLs and the still-image-detecting APLs are to be calculated according to the embodiment;

FIG. 5 is a schematic view showing blocks for which the peak-detecting APLs and the still-image-detecting APLs are to be calculated according to the embodiment;

FIG. 6 is a schematic view showing blocks for which the peak-detecting APLs and the still-image-detecting APLs are to be calculated according to the embodiment;

FIG. 7 is a graph showing relationships between a time and a temperature in a left/right-side peripheral display area and an outer peripheral area at the times of the respective APLs according to the embodiment;

FIG. 8 is a graph showing relationships between a time when images at the times of the respective APLs are displayed and a temperature difference between the left/right-side peripheral display area and the outer peripheral area according to the embodiment;

FIG. 9 is a graph showing a relationship between the APL and a luminance level in a case where a predicted temperature difference is smaller than a set reference value according to the embodiment;

FIG. 10 is a graph showing a relationship between gradation and luminance according to the embodiment;

FIG. 11 is a graph showing a relationship between the APL and the luminance level in a case where the predicted temperature difference is larger than the set reference value according to the embodiment;

FIG. 12 is a flowchart showing a luminance control processing according to the embodiment;

FIG. 13 is a flowchart showing a white image detection processing according to the embodiment;

FIG. 14 is a flowchart showing a still image detection processing according to the embodiment;

FIG. 15 is a flowchart showing a peak luminance detection processing of the peripheral display area according to the embodiment;

FIGS. 16A to 16C are schematic views each showing blocks from which points of the peak-detecting APLs are to be recognized according to another embodiment of the present invention;

FIG. 17 is a schematic view showing blocks from which the points of the peak-detecting APLs are to be recognized according to still another embodiment of the present invention;

FIG. 18 is a schematic view showing blocks from which the points of the peak-detecting APLs are to be recognized according to yet another embodiment of the present invention;

FIG. 19 is a schematic view showing blocks from which the points of the peak-detecting APLs are to be recognized according to further embodiment of the present invention;

FIG. 20 is a graph showing relationships between the APL and the luminance level according to still further embodiment of the present invention; and

FIG. 21 is a block diagram showing a schematic arrangement of a display device according to yet further embodiment of the present invention.

### DETAILED DESCRIPTION OF PREFERRED EMBODIMENT(S)

An embodiment of the present invention will be described with reference to the attached drawings. In this embodiment, a display device that controls luminance of an image to a state of preventing breakage of a display section will be exemplified.

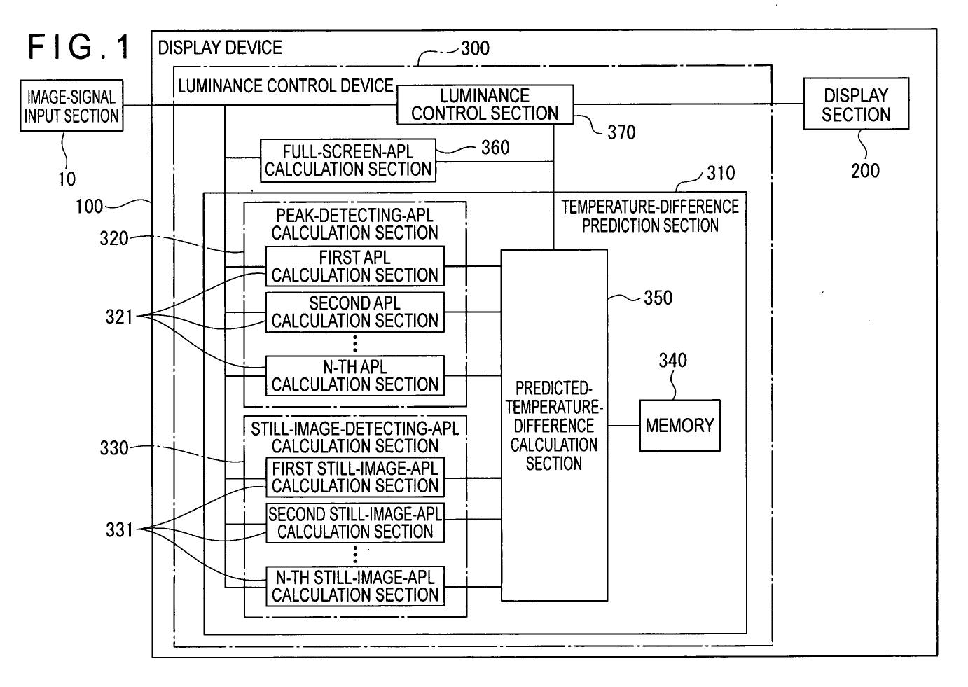

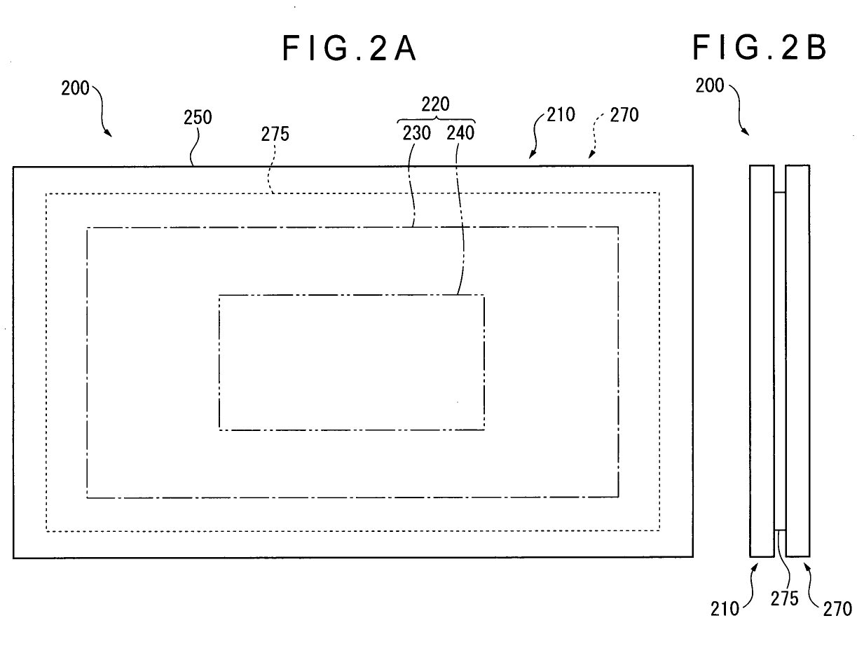

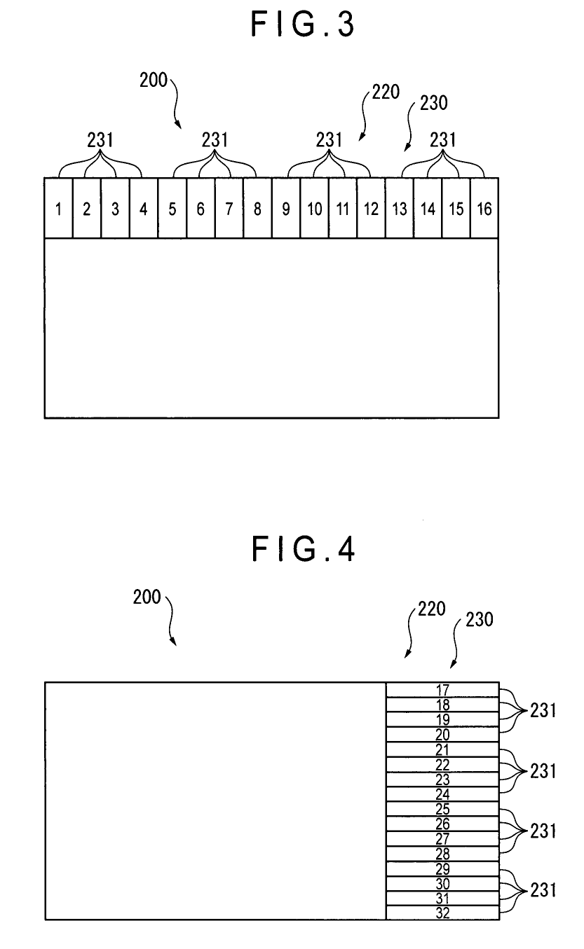

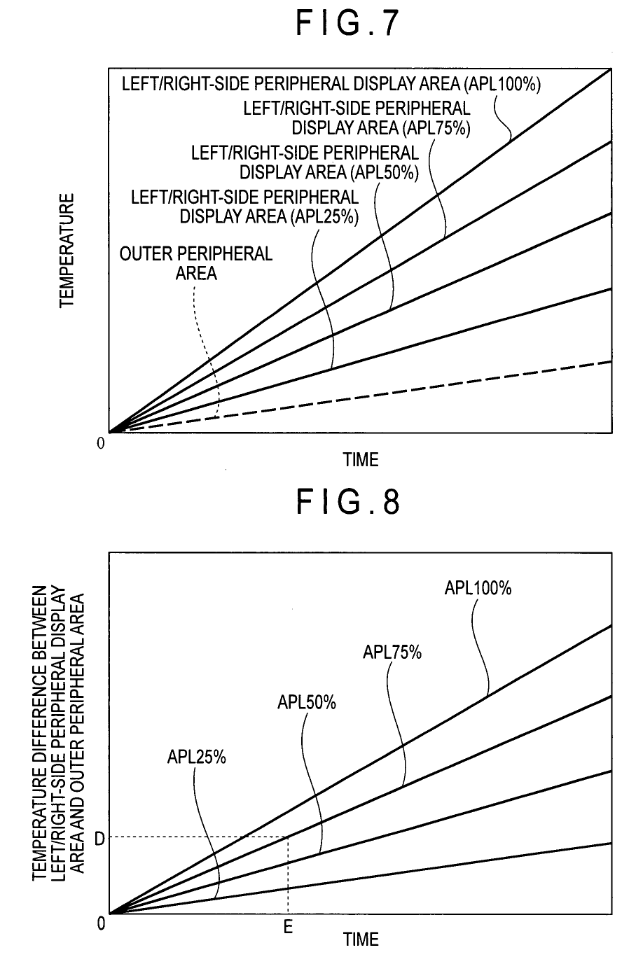

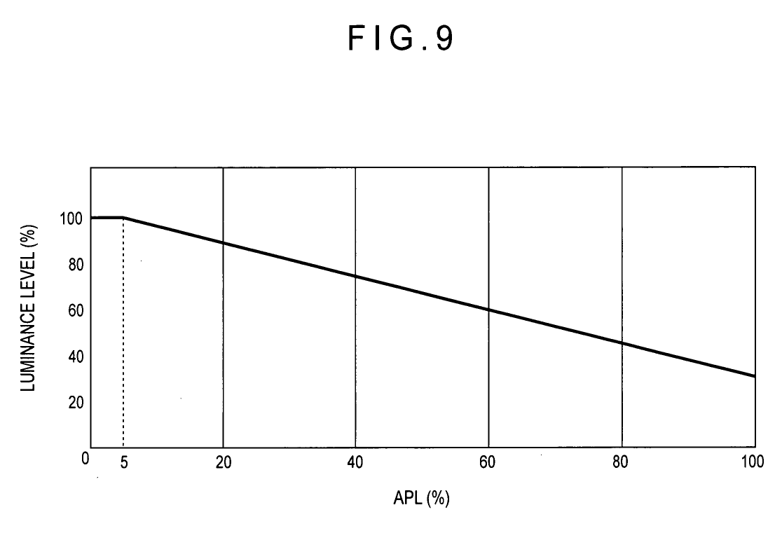

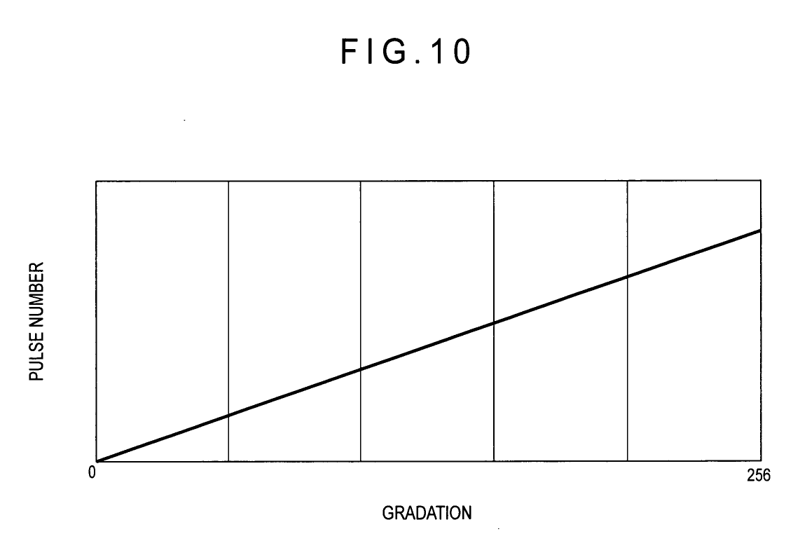

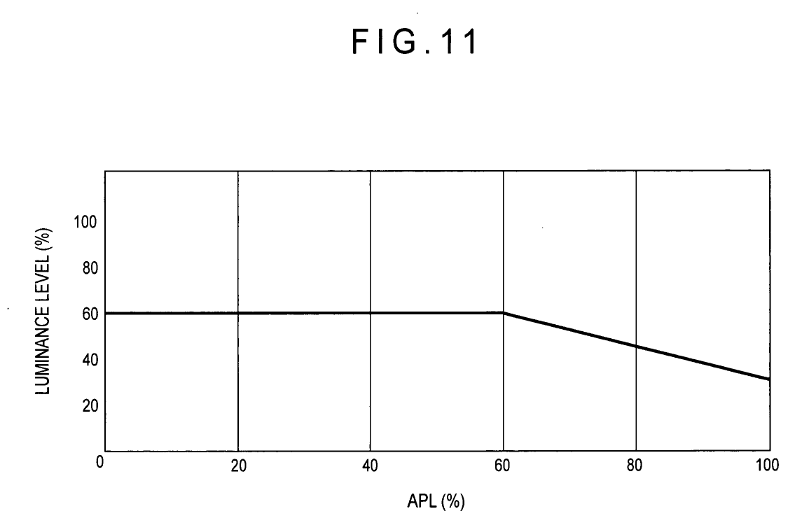

FIG. 1 is a block diagram showing a schematic arrangement of the display device according to the embodiment of the present invention. FIGS. 2A and 2B are schematic views each showing a schematic arrangement of a display section, where FIG. 2A is a plan view of the display section; and FIG. 2B is a side view thereof. FIGS. 3 to 6 are schematic views each showing blocks for which peak-detecting APLs and still-image-detecting APLs are to be calculated. FIG. 7 is a graph showing relationships between a time and a temperature in a left/right-side peripheral display area and an outer peripheral area at the times of the respective APLs. FIG. 8 is a graph showing relationships between the time and a temperature difference between the left/right-side peripheral display area and the outer peripheral area when images at the times of the respective APLs are displayed. FIG. 9 is a graph showing a relationship between the APL and a luminance level in the case where a predicted temperature difference is smaller than a set reference value. FIG. 10 is a graph showing a relationship between gradation and luminance. FIG. 11 is a graph showing a relationship between the APL and the luminance level in the case where the predicted temperature difference is larger than the set reference value.

Note that both of the temperature in FIG. 7 and the temperature difference in FIG. 8 are normally saturated in a certain period of time. However, in an experiment conducted by the inventors of the present invention, it has been understood that the breakage of the display section occurs before the temperature in FIG. 7 and the temperature difference in FIG. 8 reach saturation levels thereof. Accordingly, FIGS. 7 and 8 only show ranges where the temperature and the temperature difference rise substantially linearly with respect to the elapse of time before the temperature and the temperature difference individually reach the saturation levels.

### [Arrangement of Display Device]

In FIG. 1, reference numeral 100 denotes a display device. The display device 100 includes a display section 200 and a luminance control device 300 as a computing unit, and the like.

The display section 200 displays an image based on a display image signal outputted from the luminance control device 300. Then, as shown in FIGS. 2A and 2B, the display section 200 includes a PDP 210 and a heat-radiating chassis 270 as a heat-radiating member, and the like.

The PDP 210 includes substantially rectangular front and back substrates arranged opposite to each other, and the like. The PDP 210 includes a display area 220 capable of displaying an image thereon, and an outer peripheral area 250 not capable of displaying an image thereon.

The display area 220 has a rectangular shape and is provided on an in-plane side in a manner apart from an outer edge of the PDP 210 by a predetermined distance. In a portion of the PDP 210, which corresponds to the display area 220, an electrode, a dielectric layer, a fluorescent layer, and the like (all of which are not shown) are arranged. On the display area 220, the image based on the display image signal from the luminance control device 300 is appropriately displayed.

Further, the display area 220 includes a peripheral display area 230, and a center display area 240.

The peripheral display area 230 corresponds to areas adjacent to the outer peripheral area 250, among total of sixteen areas obtained by dividing the display area 220 into four zones in a vertical direction and into four zones in a horizontal direction.

The center display area 240 is an area surrounded by the peripheral display area 230.

Note that two sides of the peripheral display area 230, which are adjacent to the left and right sides of the center display area 240, will be appropriately referred to as left/right-side peripheral display areas 230, while two sides of the peripheral display area 230, which are adjacent to the upper and lower sides of the center display area 240, will be appropriately referred to as upper/lower-side peripheral display areas 230, and a description will be made of these areas as appropriate. Further, four areas of the peripheral display area 230 on the upper left and right sides and lower left and right sides of the center display area 240 are not included in any of the left/right-side peripheral display areas 230 and the upper/lower-side peripheral display areas 230. These four areas are areas of the peripheral display area 230, which are located on the left and right sides of the center display area 240 and the upper and lower sides thereof, respectively.

The heat-radiating chassis 270 is provided on a back surface of the PDP 210. The heat-radiating chassis 270 includes a chassis base portion (not shown) having a rectangular plate shape substantially the same as that of the PDP 210 and formed of metal such as aluminum. On an outer edge of the chassis base portion, a side surface portion upright in a perpendicular direction on one surface of the chassis base portion is provided continuously. Further, on the one surface of the chassis base portion, a plurality of heat radiation fins (not shown) may be provided at, for example, a nearly equal interval in a longitudinal direction.

Then, the heat-radiating chassis 270 is fixedly attached to the PDP 210 by a double-sided tape 275 as an adhesive in a state where a surface of the chassis base portion, on which the heat radiation fins are not provided, is opposed to the back surface of the PDP 210. The double-sided tape 275 is larger than an outer shape of the display area 220 and smaller than an outer shape of the outer peripheral area 250. Alternatively, the double-sided tape 275 may be adhered entirely to the display area 220 and the outer peripheral area 250. With this arrangement, a temperature difference between the outer peripheral area 250 and the peripheral display area 230 less likely occur.

Thus, the PDP 210 is brought into intimate contact with the heat-radiating chassis 270 through the double-sided tape 275. Accordingly, heat transferred from the PDP 210 is released from the heat radiation fins through the heat-radiating chassis 270 into the air.

As shown in FIG. 1, the luminance control device 300 is detachably connected to an image-signal input section 10. The luminance control device 300 acquires an input image signal that is inputted from the image-signal input section 10 and is subjected to, for example, γ correction. Then, the luminance control device 300 sets luminance of an image of the input image signal to a value at which the display section 200 is not broken due to the temperature difference between the display area 220 and the outer peripheral area 250. Further, the luminance control device 300 outputs a display image signal for displaying the image with the set luminance to the display section 200.

The luminance control device 300 includes a temperature-difference prediction section 310, a full-screen-average picture level (APL) calculation section 360 as an average picture level calculation section, a luminance control section 370 also functioning as a display-image-signal generating section, and the like.

The temperature-difference prediction section 310 predicts a temperature difference between the peripheral display area 230 of the display area 220 and the outer peripheral area 250 based on the input image signal.

The temperature-difference prediction section 310 includes a peak-detecting-APL calculation section 320 as an accumulated-value calculation section, a still-image-detecting-APL calculation section 330 as a motion signal generating section, a memory 340 as a accumulated-value storing unit, a predicted-temperature-difference calculation section 350, and the like.

The peak-detecting-APL calculation section 320 calculates the peak-detecting APL as an accumulated value of input image signal levels in a predetermined area including the peripheral display area 230, and outputs the peak-detecting APL to the predicted-temperature-difference calculation section 350.

The peak-detecting-APL calculation section 320 includes sixty four pieces of APL calculation sections 321. These APL calculation sections 321 are connected to the image-signal input section 10 and the predicted-temperature-difference calculation section 350, acquires the input image signals from the image-signal input section 10, and calculates the respective APLs (hereinafter, referred to as peak-detecting APLs) of sixty four blocks 231 as peripheral sub-areas as shown in FIGS. 3 to 6. As will be described later, the predicted-temperature-difference calculation section 350 detects ten APLs of which values are large from the sixty four APLs, and a peak APL of which values are the maximum.

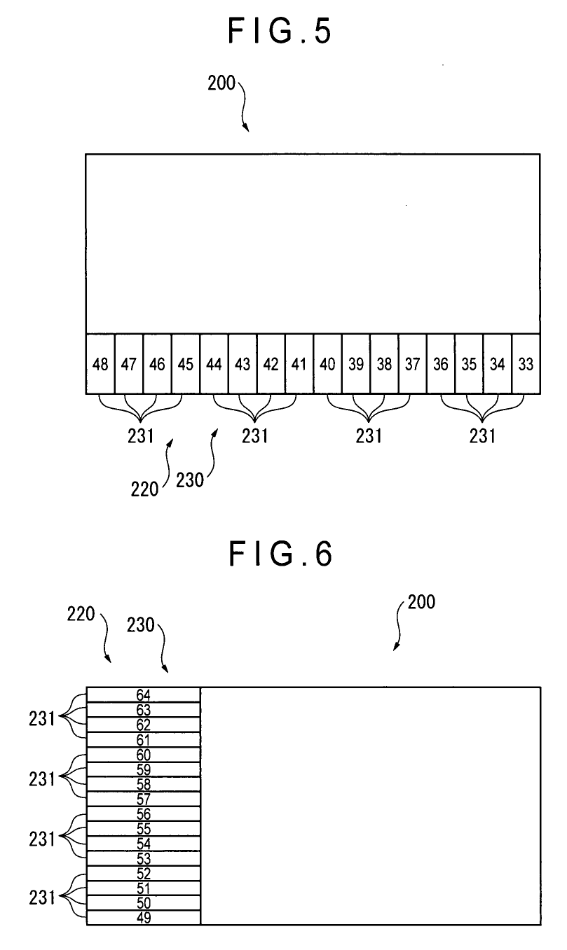

Here, as shown in FIG. 3, the first to sixteenth blocks 231 are the respective areas obtained by dividing the peripheral display area 230 above the center display area 240 into sixteen zones in the horizontal direction. As shown in FIG. 4, the seventeenth to thirty-second blocks 231 are the respective areas obtained by dividing the right-side peripheral display area 230 into sixteen zones in the vertical direction. As shown in FIG. 5, the thirty-third to forty-eighth blocks 231 are the respective areas obtained by dividing the peripheral display area 230 below the center display area 240 into sixteen zones in the horizontal direction. As shown in FIG. 6, the forty-ninth to sixty-fourth blocks 231 are the respective areas obtained by dividing the left-side peripheral display area 230 into sixteen zones in the vertical direction.

These first to sixty-fourth blocks 231 have areas equal to one another, and have pixels (not shown), each number of which is equal to the others.

Then, each of the APL calculation sections 321 calculates the peak-detecting APL in the following manner.

Specifically, each of the APL calculation sections 321 recognizes gradations corresponding to the input image signals in the respective pixels of the corresponding blocks 231, and obtains a distribution of the gradations. Then, by using a distribution in which the gradations are seven or more, the APL calculation section 321 calculates the peak-detecting APL based on the following Expression 1.

P=((G7)×7/15+(G8)×8/15+(G9)×9/15+(G10)×10/15+(G11)×11/15+(G12)×12/15+(G13)×13/15+(G14)×14/15+(G15)×15/15)/(GA))×100 [Expression 1]

P: APL (%)

GA: total number of pixels of the blocks 231

GL (L=7 to 15): number of pixels in which the gradations are L

For example, when the distribution is as shown in the following Table 1, the APL calculation section 321 calculates that the peak-detecting APL is approximately 32%.

TABLE 1

| | Gradation | | | | | | | | | | | | | | | |
|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 |
| No. of pixels | 200 | 0 | 300 | 0 | 0 | 100 | 0 | 0 | 0 | 24 | 0 | 0 | 400 | 0 | 0 | 0 |

Then, each of the APL calculation sections 321 calculates the peak-detecting APLs based on Expression 1, for example, every sixty seconds, and outputs the peak-detecting APL together with an address of the block 231 to the predicted-temperature-difference calculation section 350.

The still-image-detecting-APL calculation section 330 includes sixty four pieces of still-image-APL calculation sections 331. These still-image-APL calculation section 331 are connected to the image-signal input section 10 and the predicted-temperature-difference calculation section 350, acquires the input image signals from the image-signal input section 10, and calculates as respective APLs (hereinafter, referred to as still-image-detecting APLs) of the first to sixty-fourth blocks 231.

Specifically, each of the still-image-APL calculation sections 331 calculates the APLs based on the above-mentioned Expression 1 as the still-image-detecting APLs, for example, every ten seconds, and generates still-image-detecting APL signals as motion signals. Then, each of the still-image-APL calculation sections 331 outputs the still-image-detecting APL signals together with the address of the block 231 to the predicted-temperature-difference calculation section 350.

Note that, though the arrangement in which the sixty four APL calculation sections 321 are provided has been illustrated above, an arrangement may be employed, in which, for example, only two APL calculation sections 321 are provided, and each of the APL calculation sections 321 calculates the peak-detecting APLs of thirty two blocks 231. Further, also for the still-image-APL calculation section 331, a similar arrangement may be adopted. Further, an arrangement may be adopted, in which a size of the blocks 231 for which the peak-detecting APLs are to be calculated and a size of the blocks 231 for which the still-image-detecting APLs are to be calculated are differentiated from each other.

The memory 340 is connected to the predicted-temperature-difference calculation section 350. The memory 340 has a capacity enough to store a total value of points (to be described later) of the peak-detecting APLs regarding ten blocks 231.

The predicted-temperature-difference calculation section 350 is connected to the full-screen-APL calculation section 360 and the luminance control section 370. The predicted-temperature-difference calculation section 350 calculates the predicted temperature difference based on white-image-detecting APLs (to be described later) outputted from the full-screen-APL calculation section 360, the still-image-detecting APLs, and the peak-detecting APLs. Although details will be described later, the white-image-detecting APLs are obtained based on the input image signals. Specifically, the predicted-temperature-difference calculation section 350 calculates the predicted temperature difference between the peripheral display area 230 and the outer peripheral area 250 based only on the input image signals.

Here, a relationship between the predicted temperature difference and the input image signals for use in the case of calculating the predicted temperature difference will be described.

As descried above, the display section 200 has the arrangement in which the heat-radiating chassis 270 is provided on the PDP 210. Accordingly, it is experimentally understood that the display section 200 has characteristics as described below.

Specifically, relationships between the time and the temperature at the time of respective APLs in the left/right-side peripheral display area 230, that is, for example, the twenty-fifth block 231 shown in FIG. 4 and the outer peripheral area 250 in the vicinity of the twenty-fifth block 231, are as shown in FIG. 7. Further, since the heat-radiating chassis 270 is provided, the temperature difference between the peripheral display area 230 and the outer peripheral area 250 becomes approximately zero in a state before the image is displayed.

In view of the above, it can be considered that the relationship between the time and the temperature difference between the twenty-fifth block 231 and the outer peripheral area 250 is a relationship as shown in FIG. 8. Specifically, when a predetermined time is Δt, the temperature difference between the twenty-fifth block 231 and the outer peripheral area 250 can be determined by energy given to the outer peripheral area 250 from a point of time (T-Δt) to a point of time T, that is, by the total sum of the number of drive pulses given thereto.

Further, in general, a temperature difference between the left/right-side peripheral display areas 230 tends to be larger than a temperature difference between the upper/lower-side peripheral display areas 230. It is considered that this is because heat tends to be transferred in the vertical direction.

In view of the above, the temperature difference between the upper/lower-side peripheral display areas 230 becomes smaller than that between the left/right-side peripheral display areas 230. Accordingly, the predicted-temperature-difference calculation section 350 calculates the predicted temperature difference based on the relationships shown in FIG. 8.

Specifically, the predicted-temperature-difference calculation section 350 acquires the white-image-detecting APLs from the full-screen-APL calculation section 360 at every second. Then, in the case of recognizing that the white-image-detecting APLs that are 20% or less are nine or more out of ten continuous white-image-detecting APLs, the predicted-temperature-difference calculation section 350 judges whether or not this state has been kept for three minutes. Then, when it is judged that the state has been kept for three minutes, the predicted-temperature-difference calculation section 350 recognizes that the display section 200 may be broken (hereinafter, referred to as “panel cracking” as appropriate) due to the occurrence of the temperature difference between the peripheral display area 230 and the outer peripheral area 250 since a white image, that is, an image with high luminance is continuously displayed on the display area 220 as a whole (hereinafter, referred to as “Condition 1 is satisfied”).

Further, when it is judged that the state where the white-image-detecting APLs that are 20% or less are nine or more out of the ten continuous white-image-detecting APLs has not been kept for three minutes, the predicted-temperature-difference calculation section 350 recognizes that Condition 1 is not satisfied.

Further, the predicted-temperature-difference calculation section 350 acquires the still-image-detecting APL signals from the still-image-detecting-APL calculation section 330 at every ten seconds. Then, in the case of recognizing that differences of the still-image-detecting APL signals acquired immediately before from the still-image-detecting APLs have not changed over 1% in all the blocks 231, the predicted-temperature-difference calculation section 350 judges whether or not this state has been kept for three minutes. Then, when it is judged that the state has been kept for three minutes, the predicted-temperature-difference calculation section 350 recognizes that the panel may be cracked due to the occurrence of the temperature difference between the peripheral display area 230 and the outer peripheral area 250 when the still image is white as a whole, that is, when Condition 1 is satisfied since an almost still image is continuously displayed on the peripheral display area 230 (hereinafter, referred to as “Condition 2 is satisfied”).

Further, when it is judged that the state where the above-mentioned differences have not changed for 1% or more has not been kept for three minutes, the predicted-temperature-difference calculation section 350 recognizes that Condition 2 is not satisfied.

Further, the predicted-temperature-difference calculation section 350 acquires the peak-detecting APLs for each block from the peak-detecting-APL calculation section 320 at every sixty seconds, and converts ten APL values of the acquired peak-detecting APLs, which are relatively large, into points based on Table 2 shown below. The reason why the APL values are converted into the points is that a conversion table as shown in Table 2 has been set based on an experiment since a relationship between the accumulation of the APL values and the panel cracking is not linear.

TABLE 2

| | | Time during which panel has | |
|---|---|---|---|
| | | a possibility to crack when | |
| APL value | Point | APL-continuing state is kept | |
| 82%~100% | 50 p | 3 | (min) |
| 70%~82% | 37 p | 4 | (min) |
| 60%~70% | 30 p | 5 | (min) |
| 50%~60% | 25 p | 6 | (min) |
| 40%~50% | 22 p | 7 | (min) |
| 33%~40% | 19 p | 8 | (min) |
| 26%~33% | 17 p | 9 | (min) |
| 20%~26% | 15 p | 10 | (min) |
| 11%~20% | 14 p | 11 | (min) |
| ~19% | 0 p | ∞ | (min) |

The points shown in Table 2 are set based on an experimental result showing that the panel of the display section 200 likely cracks when a white image, i.e., an image with the APL of 100%, is kept on being displayed on the display area 220 for at least three minutes and when a state where the APL is 20% is kept for eleven minutes.

Specifically, the predicted-temperature-difference calculation section 350 converts, into the points, top ten values that are large and thus high in luminance in the peak-detecting APLs calculated by the respective APL calculation sections 321 in accordance with Table 2. Then, the predicted-temperature-difference calculation section 350 extracts the points and the addresses of the blocks 231 corresponding to the APL calculation sections 321 concerned, and stores the points and addresses in the memory 340.

Further, upon acquiring the peak-detecting APLs, the predicted-temperature-difference calculation section 350 detects the points based on Table 2, and recognizes the top ten blocks 231. Then, when the points of bottom fifty four blocks 231 are stored in the memory 340, the predicted-temperature-difference calculation section 350 deletes the points together with the addresses.

Further, when the points of the top ten blocks 231 are stored in the memory 340, the predicted-temperature-difference calculation section 350 adds up the stored points. Otherwise, the predicted-temperature-difference calculation section 350 stores the points in the memory 340 together with the addresses.

Further, in the case of recognizing that Conditions 1 and 2 are satisfied within eleven minutes from the first acquisition of the peak-detecting APLs, the predicted-temperature-difference calculation section 350 judges whether or not the block 231 in which the points are 150 or more is present. Then, when it is judged such block 231 is present, the predicted-temperature-difference calculation section 350 recognizes that the block 231 with the peak luminance has been identified (hereinafter, referred to as “Condition 3 is satisfied”).

Further, when it is judged that the block 231 in which the points are 150 or more is not present within eleven minutes, the predicted-temperature-difference calculation section 350 recognizes that Condition 3 is not satisfied.

Then, in the case of recognizing that all Conditions 1 to 3 are satisfied, the predicted-temperature-difference calculation section 350 judges that the PDP 210 has a possibility of panel cracking, and calculates the predicted temperature difference.

In the case where the APL of the block 231 as a specific sub-area continuously takes the same value, the predicted-temperature-difference calculation section 350 judges that the PDP 210 has a possibility of the panel cracking when the temperature difference of the graph in FIG. 8 reaches a predetermined value D. However, since there are actually many cases where the APLs for each of the blocks 231 are changed, the predicted-temperature-difference calculation section 350 converts the APL values into the points in accordance with Table 2 in a manner to be described later, and calculates the predicted temperature difference based on an accumulated value of the points.

In this calculation, for example, when the points based on Table 2 are 150 points or more, the predicted-temperature-difference calculation section 350 calculates that the predicted temperature difference is, for example, 30° C. or more, at which the PDP 210 has a possibility of the panel cracking.

The full-screen-APL calculation section 360 is connected to the image-signal input section 10 and the luminance control section 370. The full-screen-APL calculation section 360 calculates the white-image-detecting APLs based on the input image signals.

Specifically, the full-screen-APL calculation section 360 acquires the input image signals at, for example, every ten seconds, and calculates the APLs for the entire range of the display area 220. Then, the full-screen-APL calculation section 360 outputs the calculated APLs as the white-image-detecting APLs to the predicted-temperature-difference calculation section 350. Further, the full-screen-APL calculation section 360 calculates the APLs as appropriate, and outputs the calculated APLs to the luminance control section 370.

The luminance control section 370 is connected to the display section 200. The luminance control section 370 controls the luminance of the image of the input image signals based on the predicted temperature difference from the predicted-temperature-difference calculation section 350.

Specifically, upon recognizing the predicted temperature difference, the luminance control section 370 judges whether or not the predicted temperature difference is larger than a preset reference value, e.g. 30° C. Then, when it is judged that the predicted temperature difference is smaller than the set reference value, the luminance control section 370 recognizes that there is a small fear of the panel cracking, and implements a luminance control as shown in FIG. 9.

Specifically, the luminance control section 370 performs a control such that the luminance level, that is, the maximum luminance becomes 100% when the APLs of the input image signals acquired from the full-screen-APL calculation section 360 are smaller than 5% and that the maximum luminance is linearly lowered as the APLs increases when the APLs are larger than 5%. Further, in this case, the luminance corresponding to the actual gradation is controlled such that the gradation and the luminance become substantially linear, where 255 gradations are defined as the white color, and zero gradation is defined as the black color. Therefore, in the case of performing a control as shown in FIG. 9, the luminance control section 370 controls a drive pulse number so as to be substantially proportional to the gradation as shown in FIG. 10.

Then, the luminance control section 370 generates a display image signal of the image, which is controlled to the state as shown in FIG. 9, and outputs the display image signal to the display section 200.

Further, when it is judged that the predicted temperature difference is larger than the set reference value, the luminance control section 370 recognizes that the possibility of the panel cracking is large, and implements a luminance control as shown in FIG. 11.

Specifically, the luminance control section 370 performs a control such that the maximum luminance becomes 60% when the APLs of the input image signals are smaller than 60%, and that the maximum luminance is linearly lowered as the APLs increases similarly to the relationship as shown in FIG. 9, for example, when the APLs of the input image signals are larger than 60%. Here, also in the case of performing the control as shown in FIG. 11, the luminance control section 370 implements the control of the drive pulse number as shown in FIG. 10 in a similar way as in the case of performing the control as shown in FIG. 9.

Then, the luminance control section 370 outputs the display image signal of the image, which is controlled to the state as shown in FIG. 11, to the display section 200.

### [Operation of Display Device]

Next, an operation of the display device 100 will be described with reference to the drawings.

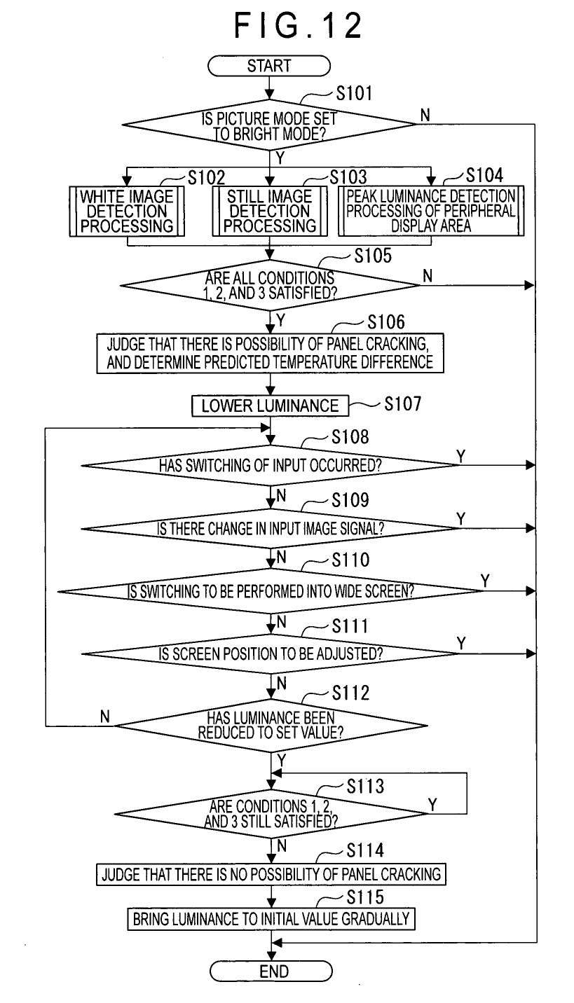

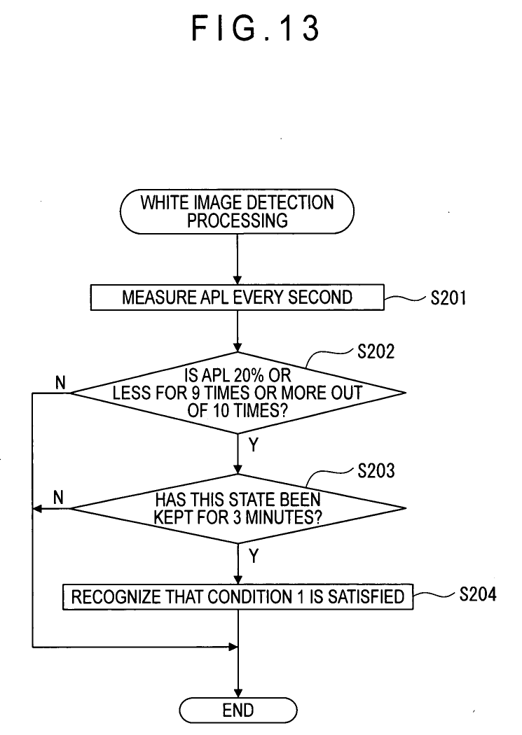

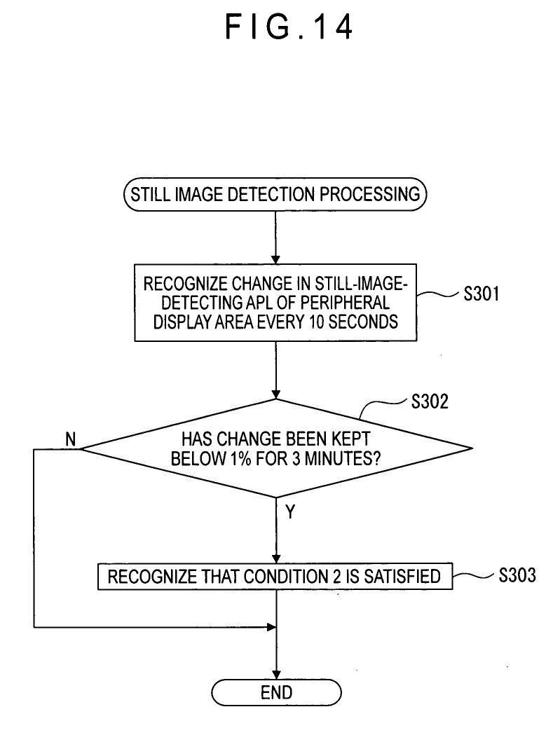

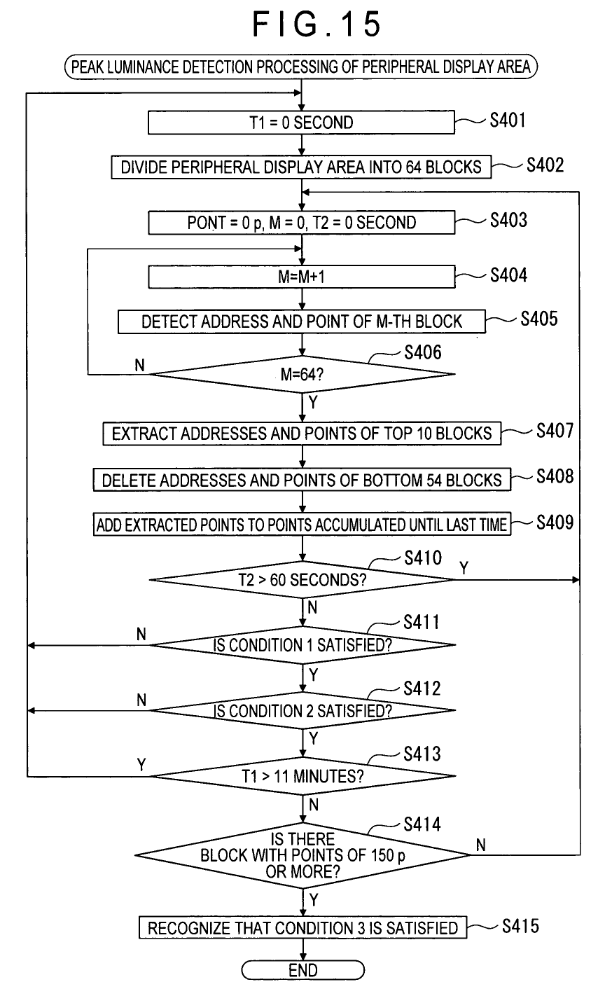

FIG. 12 is a flowchart for showing a luminance control processing. FIG. 13 is a flowchart for showing a white image detection processing. FIG. 14 is a flowchart for showing a still image detection processing. FIG. 15 is a flowchart for showing a peak luminance detection processing of the peripheral display area.

First, upon recognizing that the input image signals have been inputted from the image-signal input section 10 in the temperature-difference prediction section 310, as shown in FIG. 12, the display device 100 judges whether or not a picture mode is set to increase the luminance (Step S101). When it is judged that the picture mode is not set to increase the luminance in Step S101, the luminance control processing is terminated.

Meanwhile, when it is judged that the picture mode is set to increase the luminance, the display device 100 calculates the peak-detecting APLs and the still-image-detecting APLs in the peak-detecting-APL calculation section 320 and the still-image-detecting-APL calculation section 330. Then, the predicted-temperature-difference calculation section 350 appropriately acquires the white-image-detecting APLs from the full-screen-APL calculation section 360, and implements the white image detection processing (Step S102). Further, the predicted-temperature-difference calculation section 350 appropriately acquires the still-image-detecting APLs, and implements the still image detection processing (Step S103). Further, the predicted-temperature-difference calculation section 350 appropriately acquires the peak-detecting APLs, and implements the peak luminance detection processing of the peripheral display area 230 (Step S1104).

After implementing the processing of Steps S102 to S104, the predicted-temperature-difference calculation section 350 judges whether or not all Conditions 1 to 3 are satisfied (Step S105). When it is judged in Step S105 that all Conditions 1 to 3 are not satisfied, the luminance control processing is terminated.

Meanwhile, when it is judged that all Conditions 1 to 3 are satisfied, the predicted-temperature-difference calculation section 350 judges that there is a possibility of the panel cracking, and decides the predicted temperature difference based on the relationship shown in FIG. 8, and the like (Step S106). Then, the predicted-temperature-difference calculation section 350 outputs the predicted temperature difference to the luminance control section 370.

Upon acquiring the predicted temperature difference from the predicted-temperature-difference calculation section 350, the luminance control section 370 performs the control to lower the luminance of the image based on the predicted temperature difference, the relationships shown in FIGS. 9 to 11, and the like (Step S107).

Thereafter, the display device 100 judges whether or not switching of the input has occurred (Step S108). When it is judged in Step S108 that the switching of the input has occurred, the luminance control processing is terminated. Meanwhile, when it is judged that the switching of the input has not occurred, the display device 100 judges whether or not there is a change in the input image signals (Step S109). Then, when it is judged in Step S109 that there is a change, the luminance control processing is terminated. Further, when it is judged that there is no change in the input image signals, the display device 100 judges whether or not switching to a wide screen is to be performed (Step S110).

Then, when it is judged in Step S110 that the switching to a wide screen is to be performed, the luminance control processing is terminated. Meanwhile, when it is judged that the switching to a wide screen is not to be performed, the display device 100 judges whether or not a screen position is to be adjusted (Step S111). When it is judged in Step S111 that the screen position is to be adjusted, the luminance control processing is terminated. Meanwhile, when it is judged that the screen position is not to be adjusted, the display device 100 judges whether or not the luminance has been reduced to be lower than the set value (Step S112).

When it is judged in Step S112 that the luminance has not been reduced, the display device 100 implements processing of Step S108. Meanwhile, when it is judged that the luminance has been reduced, the display device 100 judges whether or not a state where all Conditions 1 to 3 are satisfied is kept (Step S113). When it is judged in Step S113 that all Conditions 1 to 3 are satisfied, the display device 100 implements the processing of Step S113 after a predetermined time elapses.

Meanwhile, when it is judged in Step S113 that all Conditions 1 to 3 are not satisfied, the display device 100 judges that there is no possibility of the panel cracking (Step S114). Then, the display device 100 implements processing of gradually restoring the luminance to an initial state (Step S115), and ends the luminance control processing.

Further, in the white image detection processing in Step S102, as shown in FIG. 13, the full-screen-APL calculation section 360 measures the APLs every second (Step S201), and outputs the APLs as the white-image-detecting APLs to the predicted-temperature-difference calculation section 350. Then, the predicted-temperature-difference calculation section 350 judges whether or not the white-image-detecting APLs that are 20% or less are nine or more out of the acquired ten white-image-detecting APLs, in other words, whether or not the measured APL is 20% or less in nine times or more out of ten times (Step S202). When it is judged in Step S202 that the APL is not 20% or less nine times or more out of ten times, the display device 100 recognizes that Condition 1 is not satisfied, and ends the white image detection processing.

Meanwhile, when it is judged in Step S202 that the measured APL is 20% or less in nine times or more out of ten times, the display device 100 judges whether or not this state is kept for three minutes (Step S203). Then, when it is judged in Step S203 that this state is not kept for three minutes, the white image detection processing is terminated. Meanwhile, when it is judged in Step S203 that this state is kept for three minutes, the display device 100 recognizes that Condition 1 is satisfied (Step S204), and ends the white image detection processing.

Further, in the still image detection processing in Step S103, the still-image-detecting-APL calculation section 330 measures the APLs at every ten seconds, and outputs the APLs as the still-image-detecting APLs to the predicted-temperature-difference calculation section 350. As shown in FIG. 14, the predicted-temperature-difference calculation section 350 recognizes changes in the still-image-detecting APLs of the peripheral display area 230, namely differences of the still-image-detecting APLs from those acquired immediately before at every ten seconds (Step S301). Then, the predicted-temperature-difference calculation section 350 judges whether or not the state where the above-mentioned changes have been kept below 1% has been kept for three minutes (Step S302). When it is judged in Step S302 that the state has not been kept for three minutes, the predicted-temperature-difference calculation section 350 recognizes that Condition 2 is not satisfied, and ends the still image detection processing.

Meanwhile, when it is judged in Step S302 that the state has been kept for three minutes, the predicted-temperature-difference calculation section 350 recognizes that Condition 2 is satisfied (Step S303), and ends the still image detection processing. As described above, when all the respective blocks as the peripheral sub-areas satisfy Condition 2, the predicted-temperature-difference calculation section 350 recognizes that Condition 2 is established. However, since the image is merely changed partially and Condition 2 is not satisfied in the block 231 concerned, the size of each still-image-detecting block is sometimes made larger than the size of the block of the peak-detecting APL, or the entire peripheral area is sometimes used as the still-image-detecting block.

Further, in the peak luminance detection processing of the peripheral display area 230 in Step S104, as shown in FIG. 15, the predicted-temperature-difference calculation section 350 sets a measurement time T1 of a first timer (not shown) to 0 seconds (Step S401), starts a measurement by the first timer, and divides the peripheral display area 230 into the sixty four blocks 231 (Step S402). Further, the predicted-temperature-difference calculation section 350 sets the point of each block 231 to 0 p (point), a variable M to 0, and a measurement time T2 of a second timer (not shown) to 0 seconds (Step S403), and starts a measurement by the second timer.

Thereafter, the predicted-temperature-difference calculation section 350 performs processing of setting, as a new variable M, a value obtained by adding 1 to the variable M (Step S404), and detects an address and point of an M-th block 231 (Step S405). Specifically, in Step S405, the predicted-temperature-difference calculation section 350 acquires the peak-detecting APL and the address from the APL calculation section 321 corresponding to the M-th block 231, and performs processing of detecting the point corresponding to the peak-detecting APL based on Table 2.

Then, the predicted-temperature-difference calculation section 350 judges whether or not the variable M is 64, that is, whether or not the processing of Step S404 for the sixty four blocks 231 have been implemented (Step S406). When it is judged in Step S406 that the variable M is not 64, the predicted-temperature-difference calculation section 350 implements the processing of Step S404.

Meanwhile, when it is judged that the variable M is 64, the predicted-temperature-difference calculation section 350 extracts the addresses and points of the top ten blocks 231 of which points are large out of the sixty four blocks 231 (Step S407). Thereafter, the predicted-temperature-difference calculation section 350 deletes the addresses and points of the bottom fifty four blocks 231 from the memory 340 (Step S408). Further, the predicted-temperature-difference calculation section 350 performs processing of adding the extracted points of the top ten blocks 231 to the points accumulated until the last time and stored in the memory 340 (Step S409). Note that, in the case where the points until the last time are not stored in the memory 340 in Step S409, the predicted-temperature-difference calculation section 350 performs processing of newly storing the points in the memory 340 together with the addresses.

Thereafter, the predicted-temperature-difference calculation section 350 judges whether or not the measurement time T2 is longer than sixty seconds (Step S410). Then, when it is judged in Step S410 that the measurement time T2 is longer than 60 seconds, the predicted-temperature-difference calculation section 350 implements the processing of Step S403.

Meanwhile, when it is judged in Step S410 that the measurement time T2 is shorter than 60 seconds, the predicted-temperature-difference calculation section 350 judges whether or not Condition 1 is satisfied (Step S411). When it is judged in Step S411 that Condition 1 is not satisfied, the predicted-temperature-difference calculation section 350 returns the processing to Step S401. Meanwhile, when it is judged in Step S411 that Condition 1 is satisfied, the predicted-temperature-difference calculation section 350 judges whether or not Condition 2 is satisfied (Step S412). When it is judged in Step S412 that Condition 2 is not satisfied, the predicted-temperature-difference calculation section 350 returns the processing to Step S401. Further, when it is judged in Step S412 that Condition 2 is satisfied, the predicted-temperature-difference calculation section 350 judges whether or not the measurement time T1 is longer than eleven minutes (Step S413).

Then, when it is judged in Step S413 that the measurement time T1 is longer than eleven minutes, the predicted-temperature-difference calculation section 350 returns the processing to Step S401. Further, when it is judged in Step S413 that the measurement time T1 is shorter than eleven minutes, the predicted-temperature-difference calculation section 350 judges whether or not the block 231 of which points are 150 p or more is present (Step S414).

When it is judged in Step S414 that the block 231 of which points are 150 p or more is not present, the predicted-temperature-difference calculation section 350 returns the processing to Step S403. Meanwhile, when it is judged in Step S414 that the block 231 of which points are 150 p or more is present, the predicted-temperature-difference calculation section 350 recognizes that Condition 3 is satisfied (Step S415), and ends the peak luminance detection processing.

### [Advantages and Effects of Display Device]

As described above, in this embodiment, the display device 100 operates the predicted-temperature-difference calculation section 350 to predict the predicted temperature difference between the peripheral display area 230 and the outer peripheral area 250 of the display section 200 based on the input image signals from the image-signal input section 10. Then, when the predicted temperature difference is equal to or more than the set reference value, the display device 100 performs the control to lower the luminance of the image displayed on the peripheral display area 230. Specifically, the display device 100 performs the control to lower the luminance in response to the increase in the predicted temperature difference.

Therefore, the display device 100 predicts the predicted temperature difference only by using the input image signals, thus making it possible to perform an appropriate control for the luminance of the image displayed on the peripheral display area 230 without implementing the calculation using the predicted temperature difference.

Hence, as compared with the conventional arrangement in which the predicted temperature difference is obtained by the calculation using the estimated temperature value and the reference value, the control of the luminance for the purpose of preventing the breakage of the display section 200 can be easily performed.

Further, the peripheral display area 230 is formed by the sixty four blocks 231. The display device 100 operates the peak-detecting-APL calculation section 320 to calculate the peak-detecting APLs of the input image signals displayed on the blocks 231 for each of the blocks 231. Then, the display device 100 calculates the predicted temperature difference based on the peak-detecting APL of the block 231 of which point based on Table 2 is the largest, that is, of the block 231 of which peak-detecting APL is the largest.

Therefore, the luminance is controlled based on the predicted temperature difference of the block 231 of which peak-detecting APL is the largest, that is, of the block 231 of which actual temperature difference is the largest, thus making it possible to appropriately perform the luminance control for preventing the breakage.

Further, the display device 100 generates the still-image-detecting APL signals for the input image signals displayed on the blocks 231. Then, upon recognizing that the nearly still image is continuously displayed on the peripheral display area 230 based on the still-image-detecting APLs of the still-image-detecting APL signals, the display device 100 calculates the predicted temperature difference.

Therefore, the display device 100 can calculate the predicted temperature difference of the peripheral display area 230, of which actual temperature difference is the largest, with the still image is being displayed, in which the temperature is less changeable than a motion picture, that is, a high temperature is likely maintained, thus making it possible to perform the luminance control for preventing the breakage more appropriately.

Further, the display device 100 includes the memory 340 capable of storing the points in association with the respective blocks 231 of the peripheral display area 230. Upon acquiring the peak-detecting APL of a predetermined block 231, the display device 100 adds the point of this peak-detecting APL to the points stored in the memory 340, and calculates the predicted temperature difference based on the points obtained by the addition.

Therefore, the display device 100 can calculate the predicted temperature difference of the block 231 in which the state where the temperature difference is the largest is kept for the predetermined time based on the value obtained by adding up the points of the plurality of peak-detecting APLs, thus making it possible to more appropriately perform the luminance control for preventing the breakage.

The display device 100 deletes the points of the bottom fifty four blocks 231 of which points of the peak-detecting APLs are small from the memory 340, and adds the points of the top ten blocks 231 to the points of the memory 340.

Therefore, the display device 100 allows the memory 340 to store the points of ten blocks 231 at the maximum. Accordingly, the display device 100 can reduce the capacity of the memory 340 as compared to the arrangement in which the points of all the blocks 231 are stored in the memory 340.

Further, as shown in FIG. 11, the display device 100 sets the maximum luminance of the image of the display image signal based on the predicted temperature difference.

Therefore, even if the ALPs of the input image signals are large, the display device 100 does not display an image with higher luminance than the maximum luminance, thus making it possible to prevent the breakage more securely.

Further, as shown in FIG. 11, the display device 100 performs the control to lower the maximum luminance in response to the increase of the APLs for the entire range of the display area 220.

Therefore, since the display device 100 lowers the maximum luminance in response to the increase of the APLs of the display area 220, the display device 100 can prevent the breakage more securely and can more appropriately control the display state of the image than the arrangement of not lowering the maximum luminance though the APLs are increased.

Then, as shown in FIG. 11, upon setting the maximum luminance, the display device 100 uniquely decides the relationship between the APLs of the input image signals and the maximum luminance of the display image signal.

Therefore, the display device 100 can decide the maximum luminance of the display image signal only by calculating the APLs of the input image signals, thus making it possible to perform the luminance control more easily.

Further, the heat-radiating chassis 270 is provided on the display section 200.

Therefore, the temperature difference between the peripheral display area 230 and the outer peripheral area 250 can be set to approximately zero before the image is displayed.

Hence, as shown in FIG. 8, the display device 100 can decide the predicted temperature difference without taking into account the temperature of the outer peripheral area 250, and can perform the luminance control more easily.

### [Modification of Embodiment]

Note that the present invention is not limited to the above-mentioned embodiment, and includes modifications below as long as the object of the present invention can be achieved.

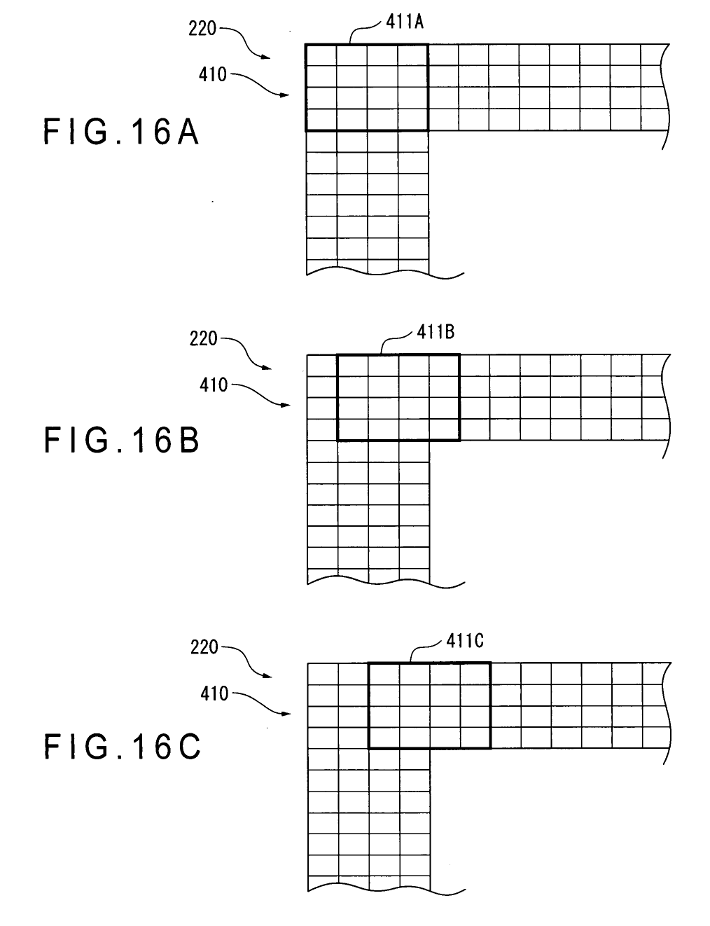

Specifically, the peripheral display area 230 can be formed into an arrangement as shown in FIGS. 16A to 16C.

Specifically, as shown in FIGS. 16A to 16C, the peripheral display area 230 may be formed into an arrangement in which points of blocks 411A, 411B and 411C are recognized as the peripheral sub-areas, which are partially overlapped with one another, in a peripheral display area 410 of the display area 220.

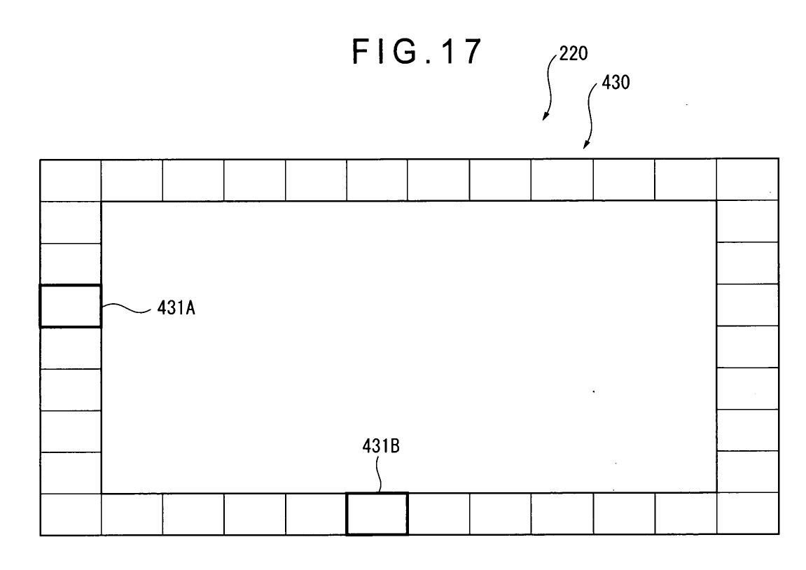

Further, the peripheral display area 410 may be formed into an arrangement as shown in FIG. 17.

In the arrangement shown in FIG. 17, in a peripheral display area 430 of the display area 220, when points of a block 431A of left/right-side blocks as the peripheral sub-areas are recognized, a value obtained, for example, by doubling the point based on Table 2 are recognized, and when points of a block 431B of upper/lower-side blocks as the peripheral sub-areas having an equal number of pixels to that of the block 431A are recognized, the point based on Table 2 is recognized as it is. Specifically, the points are calculated while assigning more weight to the point of the block 431A as one of the left/right-side blocks than to the point of the block 431B as one of the upper/lower-side blocks.

With such an arrangement, since more weight is assigned to the point of the block 431A as one of the left/right-side blocks where the breakage more likely occurs in general than in the upper/lower-side blocks. Accordingly, the luminance control for preventing the breakage can be performed more appropriately based on the point of the block 431A as one of the left/right-side blocks where the breakage likely occurs.

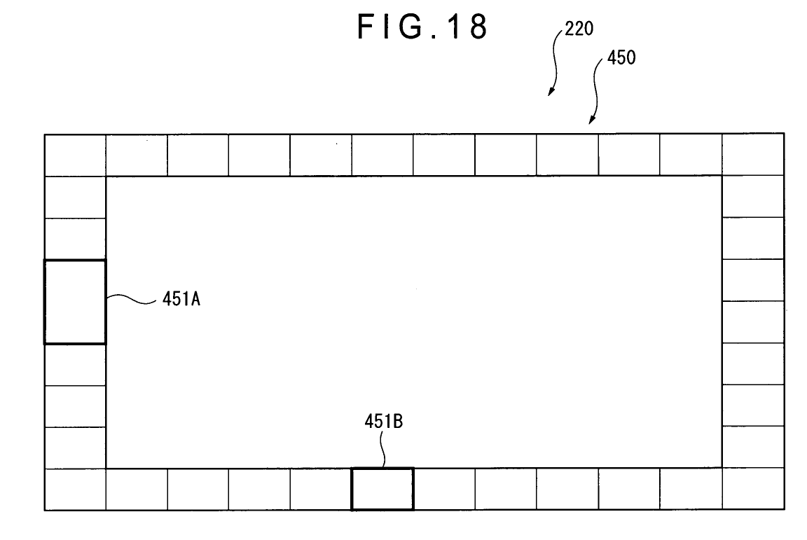

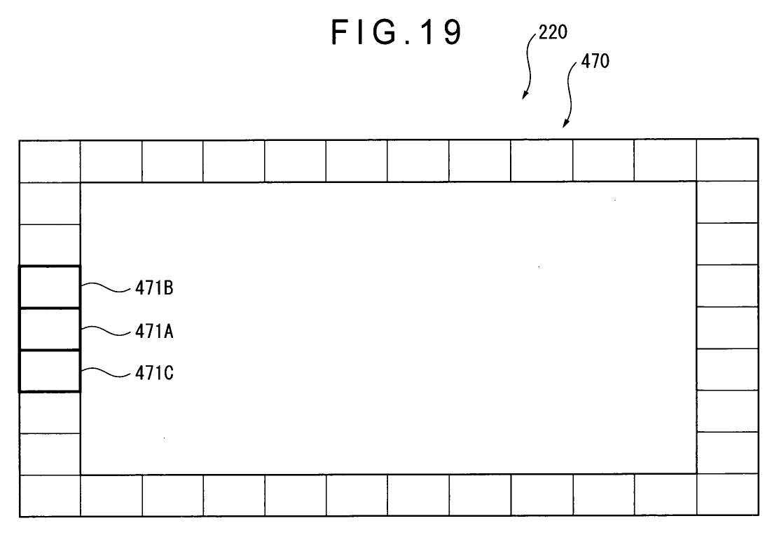

As such an arrangement of calculating the points while assigning more weight to the point of the one of the left/right-side blocks than to the point of the one of the upper/lower-side blocks, arrangements as shown in FIGS. 18 and 19 may be employed.

In the arrangement shown in FIG. 18, the weight assignment proportional to the number of pixels included in each block is performed. Specifically, in a peripheral display area 450 of the display area 220, in the case of a block 451A as one of the left/right-side blocks, and in the case of a block 451B as one of the upper/lower-side blocks, which has a less number of pixels than the block 451A, the points based on Table 2 are recognized.

Further, in the arrangement shown in FIG. 19, in a peripheral display area 470 of the display area 220, in the case where a difference between a peak-detecting APL of a block 471A as one of the left/right-side blocks and peak-detecting APLs of upper and lower blocks 471B and 471C which are located above and below the block 471A is larger than a predetermined value, that is, in the case where a temperature difference between the block 471A and the blocks 471B and 471C is larger than a predetermined value, a value for the block 471A, which is obtained by doubling the point based on Table 2, is recognized. Further, in the case of using the display device while changing an orientation thereof, it is necessary to provide a detector for the orientation of the display device.

Also with those arrangements, the luminance control for preventing the breakage can be performed more appropriately in a similar way to the arrangement shown in FIG. 17.

Note that the blocks 451A, 451B, 471A, 471B, and 471C correspond to the peripheral sub-areas of the present invention.

An arrangement in which the predicted-temperature-difference calculation section 350 calculates the predicted temperature difference as described below may be employed.

Specifically, based on the still-image-detecting APL, it is judged whether or not the image of the block 231 whose point of the peak-detecting APL is the maximum is a still image. Here, there may be employed an arrangement in which, when the image is the still image, the predicted temperature difference is calculated based on the APL of the block 231 concerned, and when the image is a motion picture, the predicted temperature difference is calculated based on the APL of the block 231 of a still image, of which point is the largest among the blocks 231 of which point sizes are the second largest and after. Specifically, there may be an arrangement in which the predicted temperature difference is calculated based on the APL of the block 231 of which point is the largest among the blocks 231 of the still image.

Note that, as a method of judging whether or not the blocks 231 are the still image, publicly known methods may be appropriately used, such as a method of making the judgment based on a change of the input image signal of the same block 231 between a current frame and a frame before the current frame, and a method of making the judgment by using a motion vector. Further, the judgment as to whether or not the image is the still image may be performed not in the unit of the block but in the unit of the frame.

Further, in the predicted-temperature-difference calculation section 350, the predicted temperature difference may be calculated in the following manner.

Specifically, predicted candidate temperature differences are individually calculated for the respective blocks 231 based on the still-image-detecting APLs and the peak-detecting APLs. As a method of calculating the predicted candidate temperature differences, the following method can be illustrated. Specifically, when a predetermined block 231 is the still image, a value obtained by multiplying, by 1.5, the temperature difference obtained based on FIG. 8 is calculated as the predicted candidate temperature difference, and when this predetermined block 231 is the motion picture, the temperature difference obtained based on FIG. 8 is calculated as the predicted candidate temperature difference. However, the method is not limited to the above-mentioned one.

The largest predicted candidate temperature difference among the predicted candidate temperature differences of the respective blocks 231 may be outputted as the predicted temperature difference to the luminance control section 370.

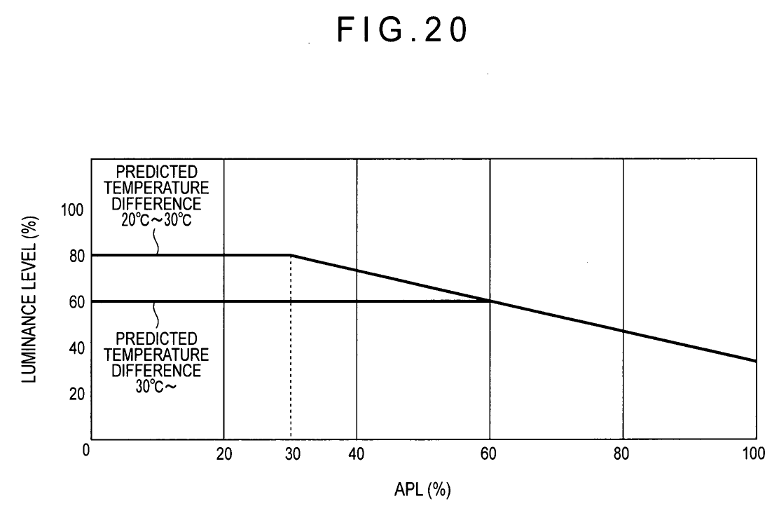

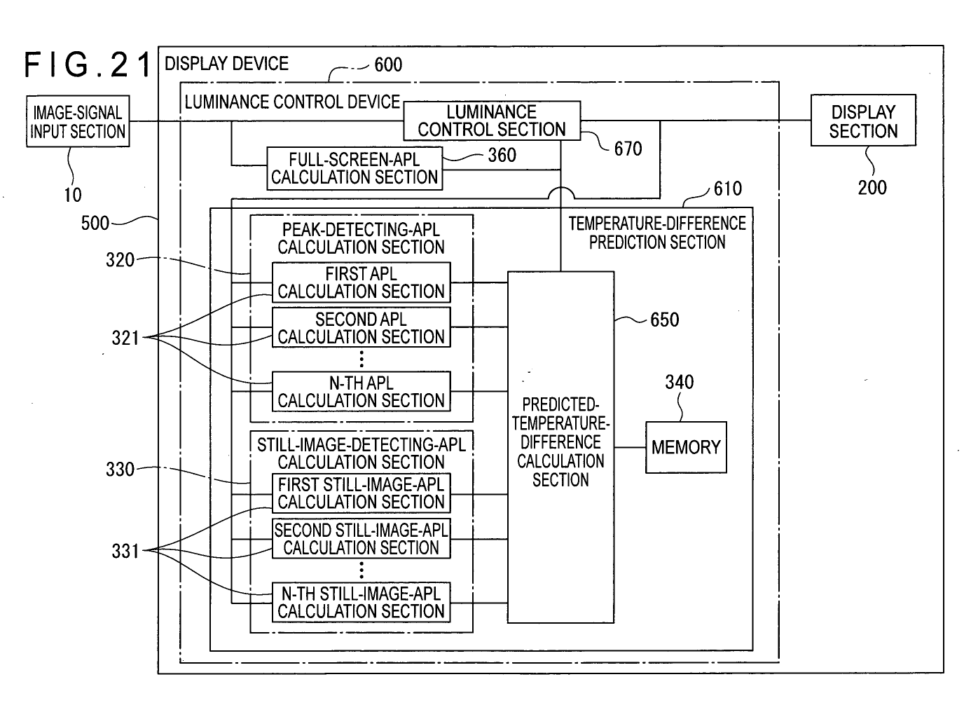

Further, as shown in FIG. 20, the luminance of the image of the input image signal may be controlled.

Specifically, when the predicted temperature difference is larger than 30° C., the luminance control is performed in a similar way to FIG. 11. When the predicted temperature difference is 20° C. to 30° C., the control may be performed so that the maximum luminance is set to 80% when the APLs of the input image signals are less than 30%, and the maximum luminance is reduced in a linear state with the increase of the APLs in a similar way to the case where the predicted temperature difference is larger than 30° C. when the APLs of the input image signals are more than 30%.

With such an arrangement, the luminance can be controlled more finely in accordance with the state of the image than with the arrangement of the above-mentioned embodiment.

Further, the luminance of the image of the input image signals may be controlled in the following manner.

Specifically, the peak-detecting APL of a predetermined block 231 is calculated. The peak-detecting APL is converted into the APL of the display image signal based on, for example, the maximum luminance obtained based on FIG. 9. Further, a value obtained through the conversion is converted into a temperature rise value. In this case, the conversion is performed so that the temperature rise value in the case where the block 231 is the still image can be larger than in the case where the block 231 is the motion picture in consideration of the still-image-detecting APLs. The temperature rise values are added up every predetermined time. When a total value of the temperature rise values in any of the blocks 231 reaches a predetermined value or more, the luminance control, for example, as shown in FIG. 11, is started.

Further, with such an arrangement and the arrangement of the above-mentioned embodiment, after the luminance control of FIG. 11 is kept for a predetermined time of, for example, thirty minutes, the luminance control may be returned to the control of FIG. 9 irrespective of the APLs of the input image signals.

Further, though the predicted temperature difference is calculated based on the input image signals in the above-mentioned embodiment, as shown in FIG. 21, the predicted temperature difference may be calculated based on the display image signal.

In a luminance control device 600 as a computing unit of a display device 500 shown in FIG. 21, a temperature-difference prediction section 610 and a luminance control section 670 also functioning as a display-image-signal generating section are functionally different from corresponding components in the above-mentioned embodiment. Specifically, the temperature-difference prediction section 610 is different from the corresponding component in the above-mentioned embodiment in an arrangement in which the peak-detecting-APL calculation section 320 and the still-image-detecting-APL calculation section 330 are connected not to the image-signal input section 10 but to the luminance control section 670, and in a function of a predicted-temperature-difference calculation section 650.

For the input image signals, the peak-detecting-APL calculation section 320 and the still-image-detecting-APL calculation section 330 acquire the display image signal subjected to, for example, the luminance control as shown in FIG. 9 from the luminance control section 670. Then, based on the display image signal, the peak-detecting-APL calculation section 320 and the still-image-detecting-APL calculation section 330 calculate the peak-detecting APL and the still-image-detecting APL, and output the calculated peak-detecting APL and still-image-detecting APL to the predicted-temperature-difference calculation section 650.

Based on the peak-detecting APL and the still-image-detecting APL based on the display image signal, the white-image-detecting APL, and the like, the predicted-temperature-difference calculation section 650 performs the same processing as that of the predicted-temperature-difference calculation section 350 of the above-mentioned embodiment, obtains the predicted temperature difference, and outputs the obtained predicted temperature difference to the luminance control section 670.

Then, the luminance control section 670 performs the luminance control based on the predicted temperature difference calculated based on the display image signal from the predicted-temperature-difference calculation section 650.

Also with such an arrangement, the same advantages and effects as those of the above-mentioned embodiment can be attained. Further, the predicted temperature difference in the image actually displayed on the display section 200 is calculated, and accordingly, the luminance can be controlled more appropriately than in the arrangement of the above-mentioned embodiment.

An arrangement in which modifications of the above-mentioned embodiment are combined may appropriately be employed.

Further, there may be employed an arrangement in which the predicted temperature difference is calculated without using at least one of the still-image-detecting APL and the white-image-detecting APL in the predicted-temperature-difference calculation sections 350 and 650.

With such an arrangement, a load at the time of the processing of calculating the predicted temperature difference can be reduced.

There may be employed an arrangement in which the capacity of the memory 340 is set to a capacity enough to store the points of sixty four blocks 231, and the points of the sixty four blocks 231 are constantly stored.

With such an arrangement, the load at the time of the processing of calculating the predicted temperature difference can be further reduced.

Further, an arrangement in which the heat-radiating chassis 270 is not provided to the display section 200 may be employed.

Further, an arrangement in which a heat-radiating member such as a heat-conductive sheet is provided in place of the heat-radiating chassis 270 may be employed.

The above-mentioned respective functions are constructed as a program. However, these functions may be constructed by hardware such as a circuit board, or by a single element such as an integrated circuit (IC), and can be used in either cases. Note that by employing an arrangement in which these functions are read by a computer as a computing unit from the program or a recording medium, it is possible to facilitate handling of the functions, and to easily achieve expansion of use thereof.

In addition, specific structures and procedures in carrying out the present invention can be appropriately changed into other structures and the like as long as the object of the present invention can be achieved.

### [Advantages and Effects of Embodiment]

As described above, in the embodiment described above, the display device 100 predicts the predicted temperature difference between the peripheral display area 230 and the outer peripheral area 250 of the display section 200 based on the input image signals from the image-signal input section 10. Then, when the predicted temperature difference is equal to or more than the set reference value, the display device 100 performs the control to lower the luminance of the image displayed on the peripheral display area 230.

Accordingly, the predicted temperature difference is predicted by using only the input image signals, whereby the luminance of the image displayed on the peripheral display area 230 can be controlled appropriately without implementing the calculation using the predicted temperature difference.

Hence, the display device 100 and the luminance control device 300 can be provided, in which it is easier to perform the luminance control for preventing the breakage of the display section 200 than the conventional arrangement in which the predicted temperature difference is obtained by the calculation using the estimated temperature value and the reference value.

In one modification, the display device 500 predicts the temperature difference based on the display image signal from the luminance control section 670. Then, based on the predicted temperature difference, the display device 500 performs the control to lower the luminance of the image displayed on the peripheral display area 230.

Therefore, the predicted temperature difference is predicted by using only the display image signals, and the luminance of the image displayed on the peripheral display area 230 can be controlled appropriately without implementing the calculation using the predicted temperature difference. Thus, the display device 500 and the luminance control device 600 can be provided, in which it is easy to perform the luminance control for preventing the breakage of the display section 200.

The priority application Number JP2006-084982 upon which this patent application is based are hereby incorporated by reference.

What is claimed is:

1. A luminance control device that controls luminance of an image displayed on a display section with luminance according to an input image signal inputted from an outside, the display section including: a display area that can display the image thereon, the display area having a center display area and a peripheral display area surrounding the center display area; and an outer peripheral area that cannot display the image thereon, the outer peripheral area surrounding the display area the luminance control device, comprising:
a temperature-difference prediction section that predicts a predicted temperature difference between the peripheral display area and the outer peripheral area based on the input image signal; and
a luminance control section that performs a control such that the luminance of the image displayed on the peripheral display area is lowered in accordance with an increase of the predicted temperature difference.

2. The luminance control device according to claim 1, wherein
the temperature-difference prediction section includes a motion signal generating section that generates a motion signal indicating a motion amount of the input image signal displayed on the peripheral display area, and
the predicted-temperature-difference calculation section calculates the predicted temperature difference based on the motion signal.

3. The luminance control device according to claim 1, wherein
the peripheral display area includes a plurality of peripheral sub-areas along an outer edge of the center display area, and
the temperature-difference prediction section includes: an accumulated-value calculation section that calculates an accumulated value obtained by accumulating signal levels of the input image signals displayed on the peripheral sub-areas for each of the peripheral sub-areas; and a predicted-temperature-difference calculation section that calculates the predicted temperature difference based on a largest accumulated value of the peripheral sub-area among the calculated accumulated values.

4. The luminance control device according to claim 3, wherein
more weight is assigned to the peripheral sub-area located on one of a right side and a left side of the center display area than to the peripheral sub-area located on one of an upper side and a lower side of the center display area, and
the accumulated-value calculation section calculates, as the accumulated value of one of the right side and the left side of the peripheral sub-area, the accumulated value being obtained by accumulating the signal levels of the input image signals displayed on the peripheral sub-area while reflecting the assigned weight, and as the accumulated value of one of the upper side and the lower side of the peripheral sub-area, the accumulated value being obtained by accumulating the signal levels of the input image signals displayed on the peripheral sub-area.

5. The luminance control device according to claim 3, wherein
the temperature-difference prediction section further includes a motion signal generating section that generates motion signals indicating motion amounts of the input image signals displayed on the peripheral sub-areas for each of the peripheral sub-areas, and
the predicted-temperature-difference calculation section calculates the predicted temperature difference based on the motion signals.

6. The luminance control device according to claim 1, wherein
the peripheral display area includes a plurality of peripheral sub-areas along an outer edge of the center display area, and
the temperature-difference prediction section includes: an accumulated-value calculation section that calculates accumulated values obtained by accumulating signal levels of the input image signals displayed on the peripheral sub-areas for each of the peripheral sub-areas; a motion signal generating section that generates motion signals indicating motion amounts of the input image signals displayed on the peripheral sub-areas for each of the peripheral sub-areas; and a predicted-temperature-difference calculation section that calculates predicted candidate temperature differences based on the accumulated values and the motion signals for each of the peripheral sub-areas and sets, as the predicted temperature difference, the predicted candidate temperature difference of which value is the largest among values of the calculated predicted candidate temperature differences.

7. A luminance control device that controls luminance of an image displayed on a display section with luminance according to an input image signal inputted from an outside, the display section including: a display area that can display the image thereon, the display area having a center display area and a peripheral display area surrounding the center display area; and an outer peripheral area that cannot display the image thereon, the outer peripheral area surrounding the display area, the luminance control device comprising:
a display-image-signal generating section that generates, based on the input image signal, a display image signal outputted to the display section and allowing the image to be displayed thereon;
a temperature-difference prediction section that predicts a predicted temperature difference between the peripheral display area and the outer peripheral area based on the display image signal; and
a luminance control section that performs a control such that the luminance of the image displayed on the peripheral display area is lowered in accordance with an increase of the predicted temperature difference.

8. The luminance control device according to claim 7, wherein
the temperature-difference prediction section includes a motion signal generating section that generates a motion signal indicating a motion amount of the display image signal displayed on the peripheral display area, and
the predicted-temperature-difference calculation section calculates the predicted temperature difference based on the motion signal.

9. The luminance control device according to claim 7, wherein
the peripheral display area includes a plurality of peripheral sub-areas along an outer edge of the center display area, and
the temperature-difference prediction section further includes: an accumulated-value calculation section that calculates an accumulated value obtained by accumulating signal levels of the display image signals displayed on the peripheral sub-areas for each of the peripheral sub-areas; and a predicted-temperature-difference calculation section that calculates the predicted temperature difference based on a largest accumulated value of the peripheral sub-area among the calculated accumulated values.

10. The luminance control device according to claim 9, wherein
more weight is assigned to the peripheral sub-area located on one of a right side and a left side of the center display area than to the peripheral sub-area located on one of an upper side and a lower side of the center display area, and
the accumulated-value calculation section calculates, as the accumulated value of one of the right side and the left side of the peripheral sub-area, the accumulated value being obtained by accumulating the signal levels of the display image signals displayed on the peripheral sub-area while reflecting the assigned weight, and as the accumulated value of one of the upper side and the lower side of the peripheral sub-area, the accumulated value being obtained by accumulating the signal levels of the display image signals displayed on the peripheral sub-area.

11. The luminance control device according to claim 9, wherein
the temperature-difference prediction section further includes a motion signal generating section that generates motion signals indicating motion amounts of the display image signals displayed on the peripheral sub-areas for each of the peripheral sub-areas, and
the predicted-temperature-difference calculation section calculates the predicted temperature difference based on the motion signals.

12. The luminance control device according to claim 7, wherein
the peripheral display area includes a plurality of peripheral sub-areas along an outer edge of the center display area, and
the temperature-difference prediction section includes: an accumulated-value calculation section that calculates accumulated values obtained by accumulating signal levels of the display image signals displayed on the peripheral sub-areas for each of the peripheral sub-areas; a motion signal generating section that generates motion signals indicating motion amounts of the display image signals displayed on the peripheral sub-areas for each of the peripheral sub-areas; and a predicted-temperature-difference calculation section that calculates predicted candidate temperature differences based on the accumulated values and the motion signals for each of the peripheral sub-areas, and sets, as the predicted temperature difference, the predicted candidate temperature difference of which value is the largest among values of the calculated predicted candidate temperature differences.

13. The luminance control device according to claim 3, further comprising an accumulated-value storing unit that stores the accumulated values in association with the peripheral sub-areas, wherein
the accumulated-value calculation section calculates the accumulated values at every predetermined time, and
when the accumulated values are calculated by the accumulated-value calculation section, the predicted-temperature-difference calculation section accumulates the calculated accumulated values to the accumulated values of the accumulated-value storing unit and calculates the predicted temperature difference based on the largest accumulated value of the peripheral sub-area among the calculated accumulated values.

14. The luminance control device according to claim 9, further comprising an accumulated-value storing unit that stores the accumulated values in association with the peripheral sub-areas, wherein
the accumulated-value calculation section calculates the accumulated values at every predetermined time, and
when the accumulated values are calculated by the accumulated-value calculation section, the predicted-temperature-difference calculation section accumulates the calculated accumulated values to the accumulated values of the accumulated-value storing unit and calculates the predicted temperature difference based on the largest accumulated value of the peripheral sub-area among the calculated accumulated values.

15. The luminance control device according to claim 13, wherein when the accumulated values are calculated in the accumulated-value calculation section, the predicted-temperature-difference calculation section sets priorities of the peripheral sub-areas in a descending order of the accumulated values, accumulates the accumulated values of the peripheral sub-areas of which priorities are higher than a predetermined priority to the accumulated values of the accumulated-value storing unit, and deletes the accumulated values of the peripheral sub-areas of which priorities are lower than the predetermined priority, the accumulated values to be deleted being stored in the accumulated-value storing unit.

16. The luminance control device according to claim 14, wherein when the accumulated values are calculated in the accumulated-value calculation section, the predicted-temperature-difference calculation section sets priorities of the peripheral sub-areas in a descending order of the accumulated values, accumulates the accumulated values of the peripheral sub-areas of which priorities are higher than a predetermined priority to the accumulated values of the accumulated-value storing unit, and deletes the accumulated values of the peripheral sub-areas of which priorities are lower than the predetermined priority, the accumulated values to be deleted being stored in the accumulated-value storing unit.

17. The luminance control device according to claim 1, further comprising a display-image-signal generating section that generates, based on the input image signal, a display image signal outputted to the display section and allowing the image to be displayed thereon, wherein
the luminance control section sets maximum luminance of the display image signal based on the predicted temperature difference.

18. The luminance control device according to claim 7, further comprising a display-image-signal generating section that generates, based on the input image signal, a display image signal outputted to the display section and allowing the image to be displayed thereon, wherein
the luminance control section sets maximum luminance of the display image signal based on the predicted temperature difference.

19. The luminance control device according to claim 17, further comprising an average-signal-level calculation section that counts signal levels of the input image signals displayed on the display area and calculates an average signal level of the input image signals, wherein
the luminance control section controls the maximum luminance to be lowered in accordance with an increase of the average signal level.

20. The luminance control device according to claim 18, further comprising an average-signal-level calculation section that counts signal levels of the input image signals displayed on the display area and calculates an average signal level of the input image signals, wherein
the luminance control section controls the maximum luminance to be lowered in accordance with an increase of the average signal level.

21. The luminance control device according to claim 19, wherein
the luminance control section uniquely determines a relationship between the input image signals and the display image signals upon setting the maximum luminance.

22. The luminance control device according to claim 20, wherein
the luminance control section uniquely determines a relationship between the input image signals and the display image signals upon setting the maximum luminance.

23. A display device, comprising:
a display section including: a display area that can display an image thereon, the display area having a center display area and a peripheral display area surrounding the center display area; and an outer peripheral area that cannot display the image thereon, the outer peripheral area surrounding the display area, the display section displaying the image with luminance according to an input image signal inputted from an outside; and
a luminance control device that controls the luminance of the image displayed on the display section, wherein
the luminance control device includes:
a temperature-difference prediction section that predicts a predicted temperature difference between the peripheral display area and the outer peripheral area based on the input image signal; and
a luminance control section that performs a control such that the luminance of the image displayed on the peripheral display area is lowered in accordance with an increase of the predicted temperature difference.

24. A display device, comprising:
a display section including: a display area that can display an image thereon, the display area having a center display area and a peripheral display area surrounding the center display area; and an outer peripheral area that cannot display the image thereon, the outer peripheral area surrounding the display area, the display section displaying the image with luminance according to an input image signal inputted from an outside; and
a luminance control device that controls the luminance of the image displayed on the display section, wherein
the luminance control device includes:
a display-image-signal generating section that generates, based on the input image signal, a display image signal outputted to the display section and allowing the image to be displayed thereon;
a temperature-difference prediction section that predicts a predicted temperature difference between the peripheral display area and the outer peripheral area based on the display image signal; and
a luminance control section that performs a control such that the luminance of the image displayed on the peripheral display area is lowered in accordance with an increase of the predicted temperature difference.

25. The display device according to claim 23, further comprising a heat-radiating member provided on back surfaces of the display area and the outer peripheral area.

26. The display device according to claim 24, further comprising a heat-radiating member provided on back surfaces of the display area and the outer peripheral area.

27. A luminance control method of controlling luminance of an image displayed on a display section with luminance according to an input image signal inputted from an outside, the display section including: a display area that can display the image thereon, the display area having a center display area and a peripheral display area surrounding the center display area; and an outer peripheral area that cannot display the image thereon, the outer peripheral area surrounding the display area, the luminance control method performed by a computing unit and comprising:
predicting a predicted temperature difference between the peripheral display area and the outer peripheral area based on the input image signal; and
controlling the luminance of the image displayed on the peripheral display area so as to be lowered in accordance with an increase of the predicted temperature difference.

28. A luminance control method of controlling luminance of an image displayed on a display section with luminance according to an input image signal inputted from an outside, the display section including: a display area that can display the image thereon, the display area having a center display area and a peripheral display area surrounding the center display area; and an outer peripheral area that cannot display the image thereon, the outer peripheral area surrounding the display area, the luminance control method performed by a computing unit and comprising:
generating a display image signal outputted to the display section and allowing the image to be displayed thereon, based on the input image signal;
predicting a predicted temperature difference between the peripheral display area and the outer peripheral area based on the display image signal; and
controlling the luminance of the image displayed on the peripheral display area so as to be lowered in accordance with an increase of the predicted temperature difference.

29. A luminance control program that operates a computing unit to function as a luminance control device that controls luminance of an image displayed on a display section with luminance according to an input image signal inputted from an outside, the program being readable by the computing unit, wherein
the display section includes: a display area that can display the image thereon, the display area having a center display area and a peripheral display area surrounding the center display area; and an outer peripheral area that cannot display the image thereof, the outer peripheral area surrounding the display area,
the computing unit functions as:
a temperature-difference prediction section that predicts a predicted temperature difference between the peripheral display area and the outer peripheral area based on the input image signal; and
a luminance control section that controls the luminance of the image displayed on the peripheral display area so as to be lowered in accordance with an increase of the predicted temperature difference.

30. A luminance control program that operates a computing unit to function as a luminance control device that controls luminance of an image displayed on a display section with luminance according to an input image signal inputted from an outside, the program being readable by the computing unit, wherein
the display section includes: a display area that can display the image thereon, the display area having a center display area and a peripheral display area surrounding the center display area; and an outer peripheral area that cannot display the image thereof, the outer peripheral area surrounding the display area,
the computing unit functions as:
a display-image-signal generating section that generates, based on the input image signal, a display image signal outputted to the display section and allowing the image to be displayed thereon;
a temperature-difference prediction section that predicts a predicted temperature difference between the peripheral display area and the outer peripheral area based on the display image signal; and
a luminance control section that controls the luminance of the image displayed on the peripheral display area so as to be lowered in accordance with an increase of the predicted temperature difference.

31. A luminance control program that operates a computing unit to execute a luminance control method of controlling luminance of an image displayed on a display section with luminance according to an input image signal inputted from an outside, wherein
the display section includes: a display area that can display the image thereon, the display area having a center display area and a peripheral display area surrounding the center display area; and an outer peripheral area that cannot display the image thereon, the outer peripheral area surrounding the display area,
the computing unit executes the luminance control method including:
predicting a predicted temperature difference between the peripheral display area and the outer peripheral area based on the input image signal; and
controlling the luminance of the image displayed on the peripheral display area so as to be lowered in accordance with an increase of the predicted temperature difference.

32. A luminance control program that operates a computing unit to execute a luminance control method of controlling luminance of an image displayed on a display section with luminance according to an input image signal inputted from an outside, wherein
the display section includes: a display area that can display the image thereon, the display area having a center display area and a peripheral display area surrounding the center display area; and an outer peripheral area that cannot display the image thereon, the outer peripheral area surrounding the display area,
the computing unit executes the luminance control method including:
generating, based on the input image signal, a display image signal outputted to the display section and allowing the image to be displayed thereon;
predicting a predicted temperature difference between the peripheral display area and the outer peripheral area based on the display image signal; and
controlling the luminance of the image displayed on the peripheral display area so as to be lowered in accordance with an increase of the predicted temperature difference.

33. A recording medium storing a luminance control program in a manner readable by a computing unit, the luminance control program operating the computing unit to function as a luminance control device that controls luminance of an image displayed on a display section with luminance according to an input image signal inputted from an outside, wherein
the display section includes: a display area that can display the image thereon, the display area having a center display area and a peripheral display area surrounding the center display area; and an outer peripheral area that cannot display the image thereof, the outer peripheral area surrounding the display area,
the computing unit functions as:
a temperature-difference prediction section that predicts a predicted temperature difference between the peripheral display area and the outer peripheral area based on the input image signal; and
a luminance control section that controls the luminance of the image displayed on the peripheral display area so as to be lowered in accordance with an increase of the predicted temperature difference.

34. A recording medium storing a luminance control program in a manner readable by a computing unit, the luminance control program operating the computing unit to function as a luminance control device that controls luminance of an image displayed on a display section with luminance according to an input image signal inputted from an outside, wherein
the display section includes: a display area that can display the image thereon, the display area having a center display area and a peripheral display area surrounding the center display area; and an outer peripheral area that cannot display the image thereof, the outer peripheral area surrounding the display area,
the computing unit functions as:
a display-image-signal generating section that generates, based on the input image signal, a display image signal outputted to the display section and allowing the image to be displayed thereon;
a temperature-difference prediction section that predicts a predicted temperature difference between the peripheral display area and the outer peripheral area based on the display image signal; and
a luminance control section that controls the luminance of the image displayed on the peripheral display area so as to be lowered in accordance with an increase of the predicted temperature difference.

35. A recording medium storing a luminance control program in a manner readable by a computing unit, the luminance control program operating the computing unit to execute a luminance control method of controlling luminance of an image displayed on a display section with luminance according to an input image signal inputted from an outside, wherein
the display section includes: a display area that can display the image thereon, the display area having a center display area and a peripheral display area surrounding the center display area; and an outer peripheral area that cannot display the image thereon, the outer peripheral area surrounding the display area,
the computing unit executes the luminance control method including:
predicting a predicted temperature difference between the peripheral display area and the outer peripheral area based on the input image signal; and
controlling the luminance of the image displayed on the peripheral display area so as to be lowered in accordance with an increase of the predicted temperature difference.

36. A recording medium storing a luminance control program in a manner readable by a computing unit, the luminance control program operating the computing unit to execute a luminance control method of controlling luminance of an image displayed on a display section with luminance according to an input image signal inputted from an outside, wherein
the display section includes: a display area that can display the image thereon, the display area having a center display area and a peripheral display area surrounding the center display area; and an outer peripheral area that cannot display the image thereon, the outer peripheral area surrounding the display area,
the computing unit executes the luminance control method including:
generating, based on the input image signal, a display image signal outputted to the display section and allowing the image to be displayed thereon;
predicting a predicted temperature difference between the peripheral display area and the outer peripheral area based on the display image signal; and
a controlling the luminance of the image displayed on the peripheral display area so as to be lowered in accordance with an increase of the predicted temperature difference.
